(19) United States
(12) Patent Application Publication
(10) Pub. No.: US 2015/0020033 A1
(43) Pub. Date: Jan. 15, 2015

(54) METHOD AND APPARATUS FOR ACTIVATING A USER INTERFACE FROM A LOW POWER STATE

(71) Applicant: QUALCOMM Incorporated, San Diego, CA (US)

(72) Inventors: Adam E. NEWHAM, Poway, CA (US); Michael C. BAILEY, San Diego, CA (US)

(21) Appl. No.: 13/937,912

(22) Filed: Jul. 9, 2013

(51) Int. Cl. G06F 3/0488

(52) U.S. Cl. CPC G06F 3/0488
USPC 715/863

(57) ABSTRACT

A method for activating a user interface from a low-power state using a touch-sensitive display module, the touch-sensitive display module including a touch-sensitive screen and a display, the touch-sensitive screen including a first touch-sensitive region and a second touch-sensitive region, the method including performing a continuous touch gesture on the touch-sensitive display module, the continuous touch gesture including a first gesture portion detected by the first touch-sensitive region and a second gesture portion detected by the second touch-sensitive region, the first gesture portion of the continuous touch gesture activating the second touch-sensitive region of the touch-sensitive screen.

### BACKGROUND

Many electronic devices use a touch-sensitive display. A touch-sensitive display is one that can display a visual output and that can provide a touch-sensitive surface through which to receive an input. In some implementations, a touch-sensitive screen can be bonded to, or otherwise attached to, a display to form the touch-sensitive display. While a display can be a low power consumption element, a touch-sensitive screen typically uses a touch-screen controller that coordinates and controls the operation of the touch-sensitive screen. Such a touch-screen controller typically consumes a relatively large amount of power and therefore, typically includes a “sleep” or “rest” mode where the touch-screen controller is placed into a low-power state to conserve power when the touch-sensitive screen is not in use. In many applications, a two step process is used to activate a touch-screen controller that is in a rest or sleep mode. Often, a button is pressed to activate the touch-screen controller and thus enable the touch-sensitive screen to be receptive to input, and then a touch-sensitive gesture is used to, for example, unlock the device. The button that activates the touch-screen controller can be a capacitive touch-sensitive button, or one or more capacitive touch-sensitive areas on the display. Unfortunately, this two-step process can be cumbersome, awkward, and time consuming

### SUMMARY

An embodiment of a method for activating a user interface from a low-power state using a touch-sensitive display module, the touch-sensitive display module including a touch-sensitive screen and a display, the touch-sensitive screen including a first touch-sensitive region and a second touch-sensitive region, the method comprising performing a continuous touch gesture on the touch-sensitive display module, the continuous touch gesture including a first gesture portion detected by the first touch-sensitive region and a second gesture portion detected by the second touch-sensitive region, the first gesture portion of the continuous touch gesture activating the second touch-sensitive region of the touch-sensitive screen.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram illustrating an embodiment of an apparatus for activating a user interface (UI) from a low power state.

FIG. 2 is a diagram showing a cross-sectional view of the display module of FIG. 1.

FIG. 3 is a plan view illustrating an embodiment of a touch-sensitive screen of FIGS. 1 and 2.

FIG. 4 is a plan view illustrating an alternative embodiment of a touch-sensitive screen of FIGS. 1 and 2.

FIG. 5 is a block diagram illustrating an example of a wireless device in which the apparatus and method for activating a user interface (UI) from a low power state can be implemented.

FIG. 6 is a flow chart describing an embodiment of a method for activating a user interface (UI) from a low power state.

FIG. 7 is a timing diagram that will be referred to in describing the blocks in the flowchart of FIG. 6.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used in this description, the term “touch-sensitive” may include one or more areas on a touch-sensitive screen that can be used as a way of communicating user intent to an electronic device.

As used in this description, the term “touch-sensitive screen” may include a portion of a display module that can contain, house, or otherwise be associated with one or more touch-sensitive areas that can be used as a way of communicating user intent to an electronic device.

As used in this description, the term “continuous touch gesture” is a gesture during which a user continuously touches the touch-sensitive display module, such that contact with the touch-sensitive display module is maintained throughout the entire gesture.

As in this description, the terms “user device” and “wireless device” include an electronic device capable of receiving input from a user through a touch-sensitive screen. The terms “user device” and “wireless device” may be used interchangeably in this description.

As used herein, the term “user” refers to an individual interacting with a user device or a wireless device using a touch-sensitive screen.

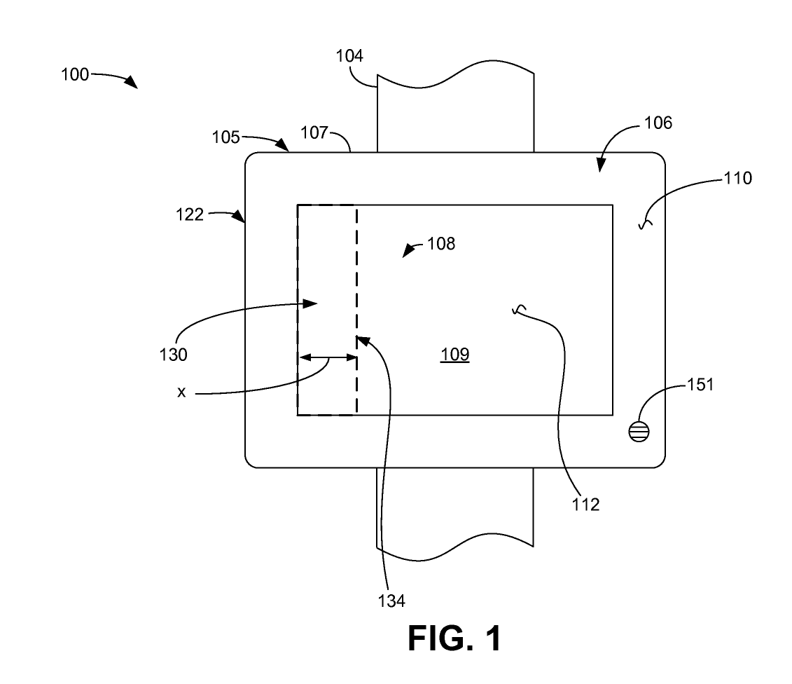

FIG. 1 is a functional block diagram illustrating an embodiment of an apparatus for activating a user interface (UI) from a low power state. In FIG. 1, the device 100 is illustrated as a wrist-worn device as one example of a user device. The apparatus for activating a user interface (UI) from a low power state can be implemented in a variety of user devices. In the embodiment shown in FIG. 1, the device 100 comprises a touch-sensitive display module 105 and a band 104. The touch-sensitive display module 105 comprises a cover glass 107 that forms a touch surface on which a user's finger comes into contact. In an embodiment, the cover glass 107 may be generally planar and may form a generally planar touch surface; however, the cover glass may be generally curved and may form a generally curved touch surface, if desired. The touch-sensitive display module 105 may also comprise a generally transparent screen protector (such as, the ZAGG invisibleSHIELD™ available from ZAGG Inc.) that may be selectively adhered to and removed from the cover glass 107, if desired. The touch-sensitive display module 105 also comprises a bezel 106 and a display 108. In an embodiment, the bezel 106 comprises a first touch-sensitive region 110 and the display 108 comprises a second touch-sensitive region 112. In an embodiment, the display 108 comprises a visible display portion 109. In an embodiment, the bezel 106 is considered to be a “non-visible” or a “non-display” portion of the touch-sensitive display module 105 because it does not provide a visible display.

In an embodiment, the first touch-sensitive region 110 and the second touch-sensitive region 112 may comprise the same touch-sensitive technology, but may be controlled, monitored, scanned, or otherwise separately operated to allow user interaction with the first touch-sensitive region 110 to control the touch receptivity of the second touch-sensitive region 112. As an example, the first touch-sensitive region 110 may comprise one or more capacitive-sensitive areas that are scanned by a touch-screen controller at a first rate; and the second touch-sensitive region 112 may comprise one or more capacitive-sensitive areas that are scanned by a touch-screen controller at a second rate. Further, the first touch-sensitive region 110 may be associated with a first touch-screen controller, or a first touch-screen controller portion, to scan the first touch-sensitive region 110 for contact at a relatively low scan rate because the first touch-sensitive region 110 is configured to be receptive to a first portion of a continuous touch gesture. In such an embodiment, the second touch-sensitive region 112 may be associated with a second touch-screen controller, or a second touch-screen controller portion that can be placed into a “sleep” or “idle” state or mode after a predetermined period of time to conserve power. In this example, a first portion of a continuous touch gesture can be applied to the first touch-sensitive region 110 and can activate the second touch-sensitive region 112, so that the second touch-sensitive region 112 becomes responsive to user input.

Alternatively, the first touch-sensitive region 110 may comprise a first touch-sensitive technology and the second touch-sensitive region 112 may comprise a second touch-sensitive technology, where the first touch-sensitive region 110 is controlled, monitored, scanned, or otherwise operated to allow user interaction with the first touch-sensitive region 110 to control the touch receptivity of the second touch-sensitive region 112.

The touch-sensitive display module 105 comprises a touch-sensitive screen 122 that may be located adjacent to and below the cover glass 107. The touch-sensitive screen 122 comprises the structure on which the first touch-sensitive region 110 and the second touch-sensitive region 112 are located and visible through the cover glass 107.

In an embodiment, the device 100 may include a microphone 151. In such an embodiment, given the close proximity of the microphone 151 to the first touch-sensitive region 110 and the second touch-sensitive region 112, a gesture on the first touch-sensitive region 110 may be audibly detected by the microphone 151 and used to activate the second touch-sensitive region 112.

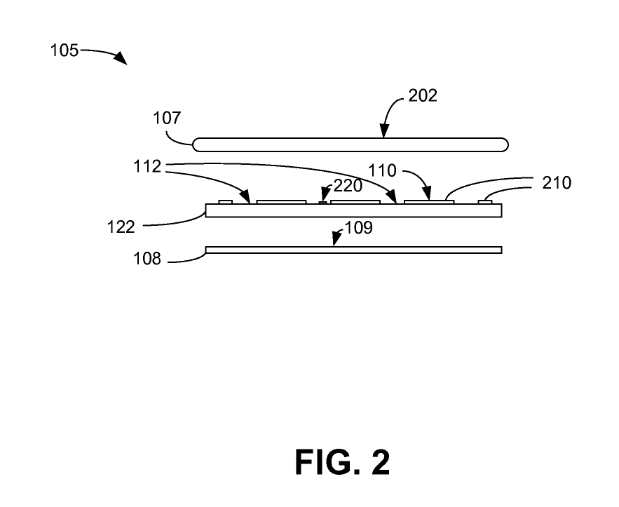

FIG. 2 is a diagram showing a cross-sectional view of the touch-sensitive display module 105 of FIG. 1. The touch-sensitive display module 105 comprises a touch-sensitive screen 122 sandwiched between a display 108 and a cover glass 107. The cover glass 107 forms a touch surface 202 on which input may be applied and communicated to the touch-sensitive screen 122. The touch-sensitive screen 122 comprises the first touch-sensitive region 110 and the second touch-sensitive region 112. In an embodiment, the first touch-sensitive region 110 comprises one or more capacitive-sensitive elements, collectively referred to as elements 210 and the second touch-sensitive region 112 comprises one or more capacitive-sensitive elements or regions, collectively referred to as elements 220. In an embodiment, the second touch-sensitive region 112 comprising the elements 220 may be located on a surface of the touch-sensitive screen 122, and may not appear as a raised element or elements, as depicted in FIG. 2 for illustration only.

In an embodiment, the elements 210 may comprise one or more capacitive-sensitive elements located anywhere on a periphery of the touch-sensitive screen 122 and are typically located on the bezel 106, or other area surrounding the visible display portion 109. The elements 210 can comprise discrete or continuous segments, portions, regions, or other forms or structures of capacitive-sensitive material. In an embodiment, the elements 210 can comprise rectangular shaped segments of capacitive-sensitive material that are located around a perimeter or periphery of the touch-sensitive screen 122.

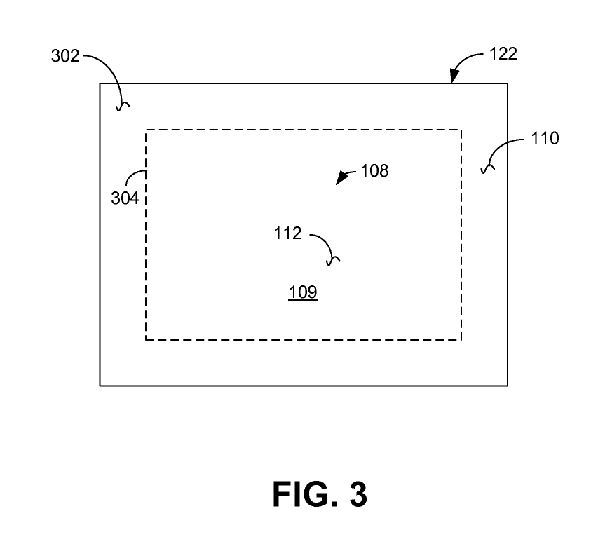

FIG. 3 is a plan view illustrating an embodiment of a touch-sensitive screen of FIGS. 1 and 2. The touch-sensitive screen 122 comprises a surface 302 having the first touch-sensitive region 110 and the second touch-sensitive region 112. In an embodiment, the first touch-sensitive region 110 is located generally around a periphery of the touch-sensitive screen 122 and the second touch-sensitive region 112 is located generally within a window 304 through which a user may view the visible display portion 109. In an embodiment, the touch-sensitive screen 122 may also include lighting to illuminate the visible display portion 109.

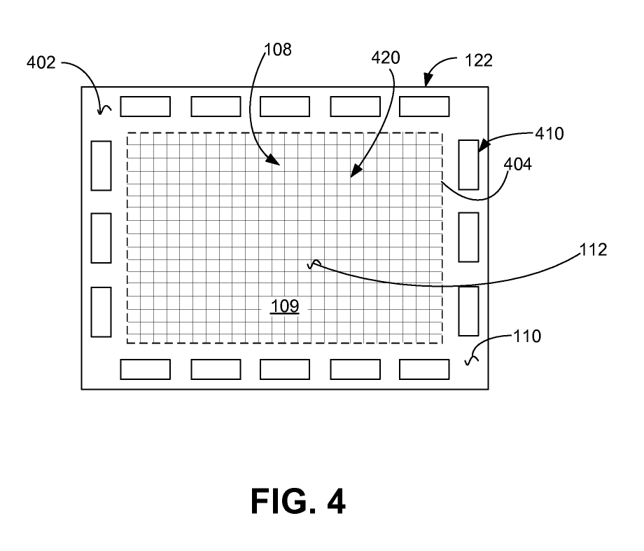

FIG. 4 is a plan view illustrating an alternative embodiment of a touch-sensitive screen of FIGS. 1 and 2. The touch-sensitive screen 122 comprises a surface 402 having the first touch-sensitive region 110 and the second touch-sensitive region 112. In an embodiment, the first touch-sensitive region 110 is located generally around a periphery of the touch-sensitive screen 122 and the second touch-sensitive region 112 is located generally within a window 404 through which a user may view the visible display portion 109.

In an embodiment, the first touch-sensitive region 110 comprises capacitive-sensitive elements, collectively referred to as elements 410 located generally around a periphery of the touch-sensitive screen 122. The second touch-sensitive region 112 may also comprise a capacitive-sensitive region, grid, or array of elements or other capacitive-sensitive structure or material, illustrated as region 420. The region 420 may comprise one or more elements 220 (FIG. 2). In an embodiment, the touch-sensitive screen 122 may also include lighting to illuminate the visible display portion 108 (FIGS. 1 and 2).

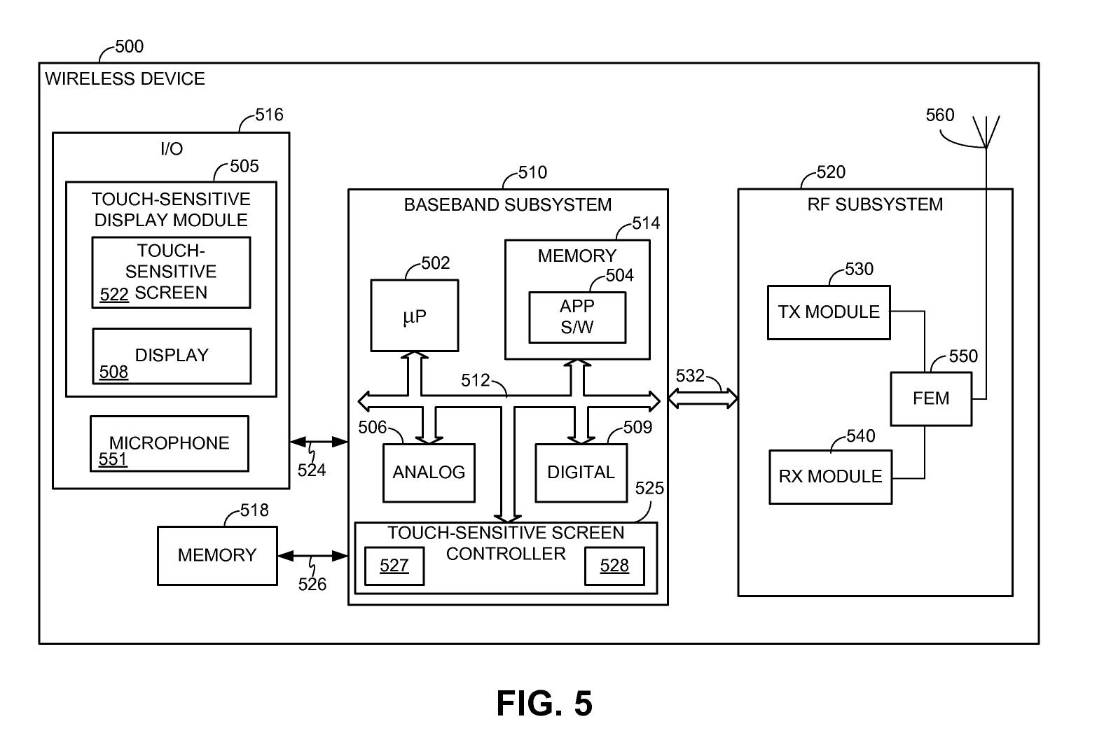

FIG. 5 is a block diagram illustrating an example of a wireless device 500 in which the apparatus and method for activating a user interface (UI) from a low power state can be implemented. In an embodiment, the wireless device 500 can be a “Bluetooth” wireless communication device, a wrist-worn wireless communication device, a portable cellular telephone, a WiFi enabled communication device, or can be any other wireless device. Embodiments of the apparatus and method for activating a user interface (UI) from a low power state can be implemented in any device or wireless device. The wireless device 500 illustrated in FIG. 5 is intended to be a simplified example of a cellular communication device and to illustrate one of many possible applications in which the apparatus and method for activating a user interface (UI) from a low power state can be implemented. One having ordinary skill in the art will understand the operation of a wireless device, and, as such, specific implementation details are omitted. In an embodiment, the wireless device 500 includes a baseband subsystem 510 and an RF subsystem 520 connected together over a system bus 532. The system bus 532 can comprise physical and logical connections that couple the above-described elements together and enable their interoperability. In an embodiment, the RF subsystem 520 can be a wireless transceiver. Although details are not shown for clarity, the RF subsystem 520 generally includes a transmit module 530 having modulation, upconversion and amplification circuitry for preparing and transmitting a baseband information signal, includes a receive module 540 having amplification, filtering and downconversion circuitry for receiving and downconverting an RF signal to a baseband information signal to recover data, and includes a front end module (FEM) 550 that includes diplexer circuitry, duplexer circuitry, or any other circuitry that can separate a transmit signal from a receive signal, as known to those skilled in the art. An antenna 560 is connected to the FEM 550.

The baseband subsystem 510 generally includes a processor 502, which can be a general purpose or special purpose microprocessor, memory 514, application software 504, analog circuit elements 506, and digital circuit elements 509, coupled over a system bus 512. The system bus 512 can comprise the physical and logical connections to couple the above-described elements together and enable their interoperability.

An input/output (I/O) element 516 is connected to the baseband subsystem 510 over connection 524 and a memory element 518 is coupled to the baseband subsystem 510 over connection 526. The I/O element 516 can include, for example, a microphone, a keypad, a speaker, a pointing device, user interface control elements, and any other devices or system that allow a user to provide input commands and receive outputs from the wireless device 500.

In a particular implementation, the I/O element 516 can include an embodiment of a touch-sensitive display module 505, which may include a touch-sensitive screen 522 and a display 508. In an embodiment, the touch-sensitive display module 505 is similar to the touch-sensitive display module 105. In an embodiment, the input/output (I/O) element 516 may include a microphone 551 located in proximity to the touch sensitive screen 522 such that a gesture on the first touch-sensitive region 110 (FIG. 1) of the touch-sensitive screen 522 may be audibly detected by the microphone 551 and used to activate the second touch-sensitive region 112 (FIG. 1) of the touch-sensitive screen 522.

The memory 518 can be any type of volatile or non-volatile memory, and in an embodiment, can include flash memory. The memory 518 can be permanently installed in the wireless device 500, or can be a removable memory element, such as a removable memory card.

The processor 502 can be any processor that executes the application software 504 to control the operation and functionality of the wireless device 500. The memory 514 can be volatile or non-volatile memory, and in an embodiment, can be non-volatile memory that stores the application software 504.

The analog circuitry 506 and the digital circuitry 509 include the signal processing, signal conversion, and logic that convert an input signal provided by the I/O element 516 to an information signal that is to be transmitted. Similarly, the analog circuitry 506 and the digital circuitry 509 include the signal processing elements used to generate an information signal that contains recovered information from a received signal. The digital circuitry 509 can include, for example, a digital signal processor (DSP), a field programmable gate array (FPGA), or any other processing device. Because the baseband subsystem 510 includes both analog and digital elements, it can be referred to as a mixed signal device (MSD).

In an embodiment, the baseband subsystem 510 also comprises a touch-sensitive screen controller 525 operatively coupled over the system bus 512. The touch-sensitive screen controller 525 may be a single element or may comprise multiple controller elements or multiple controller portions. In an embodiment, the touch-sensitive screen controller 525 comprises a first touch-sensitive screen controller portion 527 and a second touch-sensitive screen controller portion 528. In an embodiment, the first touch-sensitive screen controller portion 527 can be configured to be operative with the first touch-sensitive region 110 and the second touch-sensitive screen controller portion 528 can be configured to be operative with the second touch-sensitive region 112.

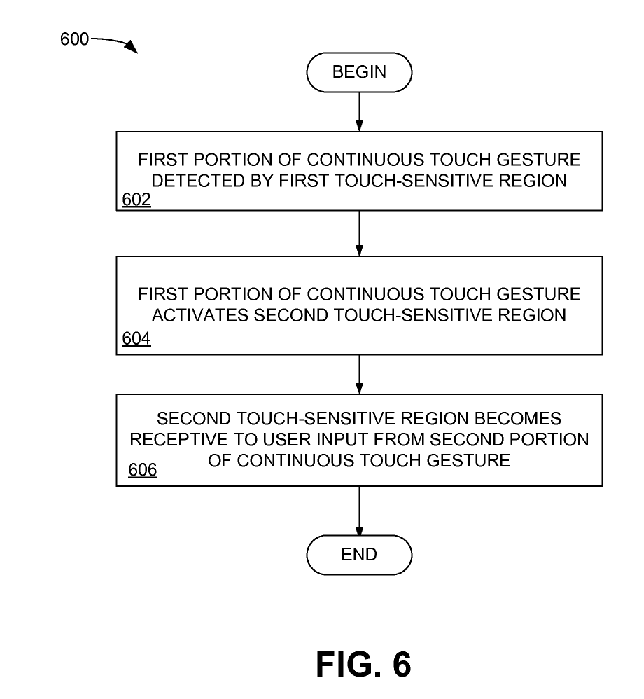

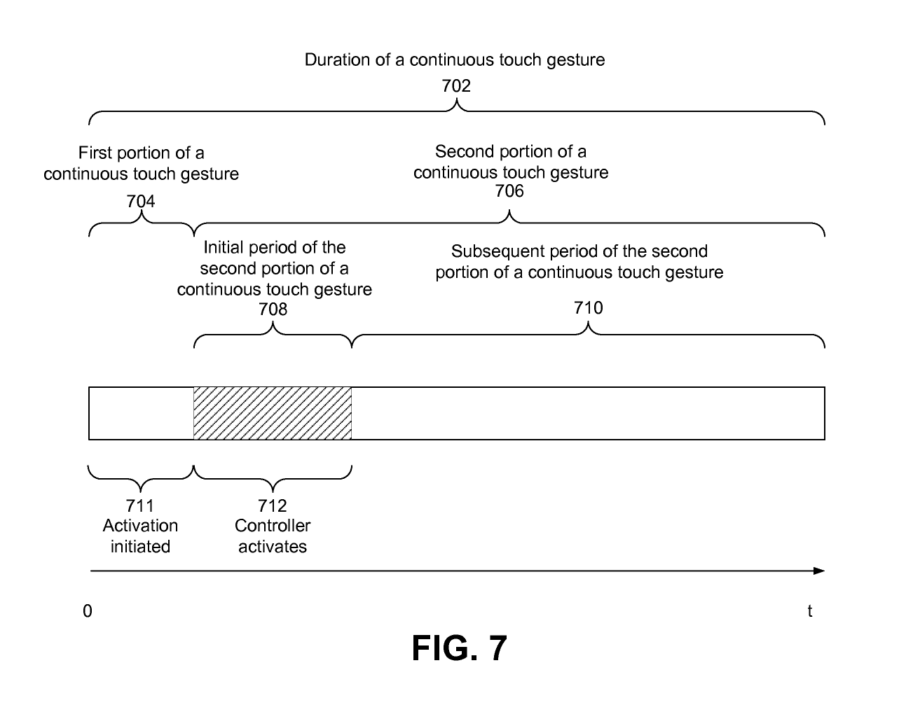

FIG. 6 is a flow chart 600 describing an embodiment of a method for activating a user interface (UI) from a low power state. FIG. 7 is a timing diagram that will be referred to in describing the blocks in the flowchart of FIG. 6.

In block 602, a first portion 704 of a continuous touch gesture 702 is detected by a first touch-sensitive region (110, FIG. 1). The first portion 704 represents the duration, beginning at time “0”, during which the continuous touch gesture 702 contacts the first touch-sensitive region 110 and initiates the activation of the second touch-sensitive region 112. This duration can be relatively short, on the order of a few microseconds (μs) to a few milliseconds (ms). Alternatively, the first portion 704 of the continuous touch gesture 702 may be audibly detected by the microphone 151.

In block 604, the first portion 704 of the continuous touch gesture 702 activates the second touch-sensitive region 112. In an embodiment, the first touch-sensitive screen controller portion 527 can control the first touch-sensitive region 110 and the second touch-sensitive screen controller portion 528 can control the second touch-sensitive region 112, such that, responsive to the first portion 704 of the continuous touch gesture 702 on the first touch-sensitive region 110, the second touch-sensitive screen controller portion 528 activates the second touch-sensitive region 112. In an embodiment, the second touch-sensitive region 112 can be in a low power state to save power and the first portion 704 of the continuous touch gesture 702 on the first touch-sensitive region 110 causes the second touch-sensitive region 112 to activate and become receptive to user input. In this example, the time period during which the second touch-sensitive screen controller portion 528 activates and causes the second touch-sensitive region 112 to become responsive to user input is represented by time period 712 and, in an embodiment, can be on the order of 25 milliseconds or other suitable time period.

To illustrate the effect of an “activation” period on the touch-sensitive screen 122, an example is given referring to FIGS. 1 and 4 in which a user initiates a continuous touch gesture 702 on one of the capacitive-sensitive elements 410 in the first touch-sensitive region 110 and then continues the continuous touch gesture 702 over the visible display portion 109 of the touch-sensitive screen 122 having the second touch-sensitive region 112. The region 130 (FIG. 1) on the touch-sensitive screen 122 represents a “dead area” associated with a time period during which the second touch-sensitive screen controller portion 528 activates and allows the second touch-sensitive region 112 to become responsive to user input (for example, a left-to-right gesture or other suitable gesture). Once the second touch-sensitive screen controller portion 528 is fully active, second touch-sensitive region 112 can be responsive to input. Using the example of a 25-millisecond time period for the second touch-sensitive screen controller portion 528 to activate, the distance “x” represents a distance that a continuous touch gesture 702 would traverse the touch-sensitive screen 122 to a line 134, during which the second touch-sensitive screen controller portion 528 and the second touch-sensitive region 112 would not yet be responsive to user input. The distance “x” and the position of the line 134 will vary based on the speed at which the continuous touch gesture 702 traverses the touch-sensitive screen 122 and the duration of the activation sequence of the second touch-sensitive screen controller portion 528. In this example, the distance “x” represents a time period of approximately 25 milliseconds during which the second touch-sensitive screen controller portion 528 activates, and the second touch-sensitive region 112 becomes receptive and responsive to user input during the subsequent period 710 of the continuous touch gesture 702.

In block 606, the second touch-sensitive screen controller portion 528 is active and causes the second touch-sensitive region 112 to be receptive and responsive to user input during the subsequent portion 710 of the continuous touch gesture 702.

The touch-sensitive screen controller 525 may also comprise logic to determine when a touch may be errant or not intended to awaken the device 100. In this example, the touch-sensitive screen controller 525 may also include logic for the detection or determination of a lack-of-gesture in order to filter and detect a false positive. For example, when a person accidently grazes or lightly touches the first touch-sensitive region 110, without the intent of activating the device 100, it is desirable to interpret such contact as not intending to activate the device and allow the touch-sensitive screen controller 525 to remain in a low-power state.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both non-transitory computer-readable storage media and also communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for activating a user interface from a low-power state using a touch-sensitive display module, the touch-sensitive display module including a touch-sensitive screen and a display, the touch-sensitive screen including a first touch-sensitive region and a second touch-sensitive region, the method comprising:
performing a continuous touch gesture on the touch-sensitive display module, the continuous touch gesture including a first gesture portion detected by the first touch-sensitive region and a second gesture portion detected by the second touch-sensitive region, the first gesture portion of the continuous touch gesture activating the second touch-sensitive region of the touch-sensitive screen.

2. The method of claim 1, wherein the second gesture portion of the continuous touch gesture provides a user input to the touch-sensitive screen through the activated second touch-sensitive region.

3. The method of claim 2, wherein the first touch-sensitive region includes a capacitive touch-sensitive region on a non-display portion of the touch-sensitive screen.

4. The method of claim 2, wherein the first touch-sensitive region includes a capacitive touch-sensitive region on a non-display portion of the touch-sensitive screen; and
wherein the second touch-sensitive region includes a capacitive touch-sensitive region on a display portion of the touch-sensitive screen.

5. The method of claim 1, wherein the second gesture portion of the continuous touch gesture detected by the second touch-sensitive region traverses a distance from the first touch-sensitive region, the distance associated with a time period during which a touch-sensitive screen controller associated with the second touch-sensitive region activates.

6. The method of claim 1, wherein the first touch-sensitive region is a capacitive touch-sensitive region located at a perimeter of the touch-sensitive screen; and
wherein the capacitive touch-sensitive region at the perimeter of the touch-sensitive screen, in response to the first gesture portion of the continuous touch gesture, activates a touch-sensitive screen controller from a rest state to an active state, such that the activated touch-sensitive screen controller detects the second gesture portion of the continuous touch gesture and, based on the second gesture portion of the continuous touch gesture, user input is provided to the touch-sensitive screen.

7. The method of claim 6, wherein the activated touch-sensitive screen controller provides a first scan rate to the first touch-sensitive region and a second scan rate to the second touch-sensitive region.

8. The method of claim 7, wherein the second scan rate is higher than the first scan rate.

9. An apparatus for activating a user-interface, the apparatus comprising:
a touch-sensitive display module including a touch-sensitive screen and a display, the touch-sensitive screen including a first touch-sensitive region and a second touch-sensitive region, wherein the touch-sensitive screen is responsive to a continuous touch gesture including a first gesture portion detected by the first touch-sensitive region and a second gesture portion detected by the second touch-sensitive region, the first gesture portion of the continuous touch gesture activating the second touch-sensitive region of the touch-sensitive screen.

10. The apparatus of claim 9, wherein the activated second touch-sensitive region is responsive to the second gesture portion of the continuous touch gesture, which provides a user input to the touch-sensitive screen.

11. The apparatus of claim 10, wherein the first touch-sensitive region includes a capacitive touch-sensitive region on a non-display portion of the touch-sensitive screen.

12. The apparatus of claim 10, wherein the first touch-sensitive region includes a capacitive touch-sensitive region on a non-display portion of the touch-sensitive screen; and
the second touch-sensitive region includes a capacitive touch-sensitive region on a display portion of the touch-sensitive screen.

13. The apparatus of claim 9, wherein the second gesture portion of the continuous touch gesture detected by the second touch-sensitive region traverses a distance from the first touch-sensitive region, the distance associated with a time period during which a touch-sensitive screen controller associated with the second touch-sensitive region activates.

14. The apparatus of claim 9, wherein the first touch-sensitive region comprises a capacitive touch-sensitive region located at a perimeter of the touch-sensitive screen; and
wherein the capacitive touch-sensitive region at the perimeter of the touch-sensitive screen, in response to the first gesture portion of the continuous touch gesture, activates a touch-sensitive screen controller from a rest state to an active state, such that the activated touch-sensitive screen controller detects the second gesture portion of the continuous touch gesture and, based on the second gesture portion of the continuous touch gesture, user input is provided to the touch-sensitive screen.

15. The apparatus of claim 14, wherein the touch-sensitive screen controller further includes:
a first controller portion configured to provide a first scan rate to the first touch-sensitive region; and
a second controller portion configured to provide a second scan rate to the second touch-sensitive region.

16. The apparatus of claim 15, wherein the second scan rate is higher than the first scan rate.

17. A method for activating a user interface from a low-power state using a device including a microphone and touch-sensitive display module, the touch-sensitive display module including a touch-sensitive screen and a display, the touch-sensitive screen including a first touch-sensitive region and a second touch-sensitive region, comprising:
performing a continuous touch gesture on the touch-sensitive display module, the continuous touch gesture including a first gesture portion detected by the microphone and a second gesture portion detected by the second touch-sensitive region, the first gesture portion of the continuous touch gesture activating the second touch-sensitive region of the touch-sensitive screen.

18. A method for activating a user interface from a low-power state using a a touch-sensitive display module, the touch-sensitive display module including a touch-sensitive screen and a display, the touch-sensitive screen including a first touch-sensitive region and a second touch-sensitive region, the method comprising:
by the first touch-sensitive region of the touch-sensitive screen, detecting a first gesture portion of a continuous touch gesture on the touch-sensitive screen;
in response to detecting the first gesture portion of the continuous touch gesture on the touch-sensitive screen, activating the second touch-sensitive region of the touch-sensitive screen; and
by the activated second touch-sensitive region of the touch-sensitive screen, detecting a second gesture portion the continuous touch gesture on the touch-sensitive screen.

19. A non-transitory computer-readable medium including processor-executable instructions for performing a method for activating a user interface from a low-power state using a a touch-sensitive display module, the touch-sensitive display module including a touch-sensitive screen and a display, the touch-sensitive screen including a first touch-sensitive region and a second touch-sensitive region, the method comprising:
by the first touch-sensitive region of the touch-sensitive screen, detecting a first gesture portion of a continuous touch gesture on the touch-sensitive screen;
in response to detecting the first gesture portion of the continuous touch gesture on the touch-sensitive screen, activating the second touch-sensitive region of the touch-sensitive screen; and
by the activated second touch-sensitive region of the touch-sensitive screen, detecting a second gesture portion the continuous touch gesture on the touch-sensitive screen.

20. An apparatus for activating a user interface from a low-power state, the apparatus comprising:
a touch-sensitive display module including:
a touch-sensitive screen including a first touch-sensitive region and a second touch-sensitive region; and
a display; and
means for, in response to the first touch-sensitive region detecting a first gesture portion of a continuous touch gesture on the touch-sensitive screen, activating the second touch-sensitive region of the touch-sensitive screen, the activated second touch-sensitive region of the touch-sensitive screen configured to detect a second gesture portion the continuous touch gesture on the touch-sensitive screen.
